(19) United States
(12) Patent Application Publication
(10) Pub. No.: US 2012/0082813 A1
(43) Pub. Date: Apr. 5, 2012

(54) Fob Keeper is a string of material modified as to repair an automobile remote fob case that is broken at the point it attaches to a key ring.

(76) Inventor: Victor Armando Horton, Louisville, KY (US)

(21) Appl. No.: 13/246,635

(22) Filed: Sep. 27, 2011

Related U.S. Application Data
(60) Provisional application No. 61/387,228, filed on Sep. 28, 2010.

(51) Int. Cl. B32B 3/28; B32B 7/12; B32B 33/00

(52) U.S. Cl. 428/40.1

(57) ABSTRACT

The Fob Keeper can be used with any automobile remote fob case. Neither the number of buttons on the remote fob nor the sizes of the remote fob are a determining factor of the Fob Keepers use. It must be attached on the inside of the remote fob. It is not necessary for the Fob Keeper to be attached to both the front and back cover, the Fob Keeper will work while being only attached to either part of the fob case.

### CROSS-REFERENCE TO RELATED APPLICATIONS

This application claims priority of U.S. provisional application no. 61/387,228 filed on Sep. 28, 2010, entitled; Fob Keeper is a string of material modified as to repair an automobile remote fob case that is broken at the point it connects to a key ring.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention relates generally to remote key less entry devices, and more particularly to the case which encloses the device.

### BACKGROUND OF THE INVENTION

Automobile remote fobs have been used for over 20 years. It has been the number 1 option on new automobiles for the last 10 years. Over time, with normal wear and tear, these remote fob cases break at the point they attach to a key ring, no longer allowing it to stay on said key ring. The Fob Keeper is intended to repair the remote fob case at the point it connects said case to a key ring.

### BRIEF SUMMARY OF THE INVENTION

Accordingly, one aspect of the present invention is to provide a repair solution when a automobile remote fob case breaks at the point it connects to a key ring.

It is yet another aspect that the type of material is insignificant to the Fob Keeper, because its the modification to the material that makes it work.

It is yet another aspect of the invention that the material that can be used includes but is not limited to nylon, polyvinylidene fluoride, polyvinyl chloride, polyethylene, Dacron, dyneema, monofilament, linen, silk, cotton, plastic or any synthetic or natural fibers.

### BRIEF DESCRIPTION OF THE DRAWING

FIG. 1 shows the material that will protrude from the automobile remote fob case once the case is reassembled

FIG. 2 shows the flat marks that indicate where the Fob Keeper will need to be placed in order for there to be enough material to be attached to a key ring.

FIG. 3 shows the double sided tape contiguous with the single sided tape

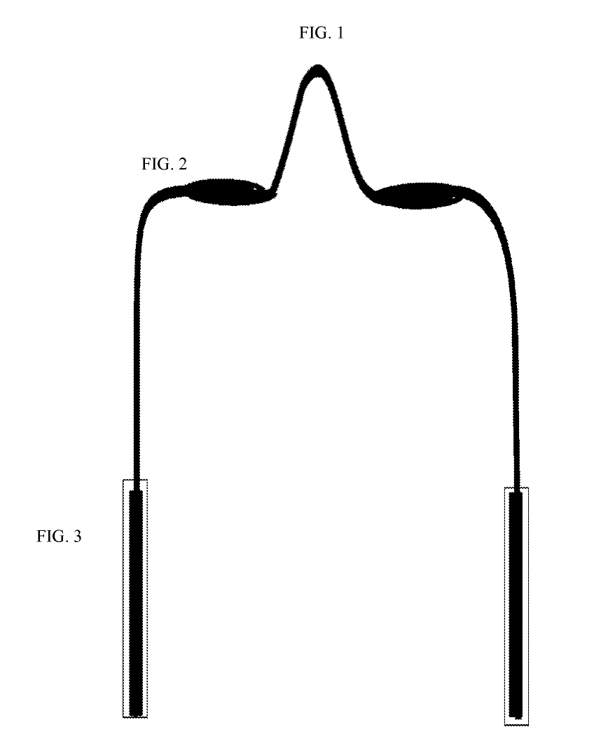

### DETAILED DESCRIPTION OF THE INVENTION

The Material is 4 inches in length. The first and last ½ inch of the material is flat with a piece of double sided tape that is ¼ inch in width and ½ inch in length, laid over a single sided piece of tape, this allows one side of the double sided tape to remain covered and to be used at time of installation. From the center of the material, starting at ¼ inch from the center on both sides, the material is flat ¼ inch going toward each end, the flat parts stops at the ½ inch mark from the center on both sides; this has two purposes, one is a reference point as to where to install the material, the second allows the automobile remote fob case to snap tight.

A simple machine press is used in the production of the Fob keeper. A template on one end of the press and a solid sheet of metal on the other end of the press will allow the Fob Keeper be produced in mass quantity. The material used is then strung across the press so that, when pressed, the material is flattened in the designated areas. The template presses the material so that the Fob Keepers are one after the other on the material. Once pressed, the double sided tape is applied to the designated areas. The sheet of Fob keepers are then taken off the machine flipped over and the single sided tape is then applied to the same areas as the double sided tape. The Sheet of Fob Keepers is then cut to separate the lines of Fob Keepers. The Lines of Fob Keepers are then cut to separate them from each other.

To install the Fob Keeper, take apart the remote fob; take out any internal components that can come out easily. To Begin, do a placement test with the Fob Keeper, simply place it on the inside of the remote and reference where it needs to be installed in order for there to be enough material, as to allow the remote to be attached to a key ring. To begin the installation process, peel the adhesive cover off one of the ends of the Fob Keeper, attach it about half way down on the left side; on the inside of the cover, of the remote fob case; or the point you referenced during the placement test. Next, peel the adhesive cover from the other end of the Fob Keeper and attach it to the right side of the remote fob case, about the same distance down as the other end of the Fob Keeper, or the other point you referenced during the placement test. Put the remote fob case back together, making sure to first reinstall any components taken out. Once together, there should be a solid line of material coming out of the remote case and then back into the remote case. The end result is a loop that can easily attach to a key ring.

1. The Fob Keeper is a device for repairing an automobile wireless remote fob case, which has broken at the point it attaches to a key ring: comprising of a 4 inch piece of material, with the last and first half inch of the material flat, with a piece of double sided tape that is ¼ inch in width and ½ inch in length and covered on one side, that is contiguous with a single sided piece of tape of the same size. From the center of the material on both sides, starting at ¼ inch from the center, the material is flat ¼ inch in length, going toward each end; the flat parts end at the ½ inch mark from the center on both sides.

2. The Fob Keeper according to claim 1, where the first and last half inch of material is covered, is in a way as to allow one side of the double sided tape to remain covered and to be used at time of installation

3. The Fob Keeper according to claim 1, where the material is flat ¼ inch from the center, ¼ inch in length, going toward each end, and ending at the ½ inch mark from the center on both sides is to serve as a means for a predetermined point, as to where to install the material as to allow enough material to create an area that can be attached to a keyring

4. The Fob Keeper according to claim 1, where the material is flat ¼ inch from the center, ¼ inch in length, going toward each end, and ending at the ½ inch mark from the center on both sides is to allow the remote to snap tight.

5. The Fob Keeper according to claim 2, can be used to repair any remote fob case, provided the material can be attached to said remote fob case.
